(19) United States
(12) Patent Application Publication
(10) Pub. No.: US 2023/0367446 A1
(43) Pub. Date: Nov. 16, 2023

(54) Methods and Apparatus for Use of Machine-Readable Codes with Human Readable Visual Cues

(71) Applicant: Mike Rosen, Apex, NC (US)

(72) Inventor: Mike Rosen, Apex, NC (US)

(21) Appl. No.: 18/225,364

(22) Filed: Jul. 24, 2023

Related U.S. Application Data
(63) Continuation of application No. 17/568,959, filed on Jan. 5, 2022.
(60) Provisional application No. 63/134,986, filed on Jan. 8, 2021.

(51) Int. Cl. G06F 3/04815; G06T 19/20; G06F 16/176

(52) U.S. Cl. CPC G06F 3/04815; G06T 19/20; G06F 16/176; G06T 2219/004; G06T 2219/024; G06T 2219/2016

(57) ABSTRACT

This disclosure pertains to the use of machine-readable codes, such as QR Codes in web and other environments, and particularly three dimensional interactive computer file collaborative interface environments for geometrically organizing, interfacing with, editing, and viewing computer files either individually, in an environment of multiple users, and/or in a collaborative environment of multiple users.

### RELATED APPLICATIONS

This application is a continuation-in-part application of U.S. patent application Ser. No. 17/568,959 filed on Jan. 5, 2022, which is incorporated herein fully by reference.

### FIELD OF THE INVENTION

This disclosure pertains to the use of machine-readable codes, such as QR Codes, in web and other environments, and particularly three dimensional interactive computer file collaborative interface environments for geometrically organizing, interfacing with, editing, and viewing computer files either individually or in a multi-user collaborative environment.

### BACKGROUND

U.S. Pat. No. 6,938,218, which is incorporated herein fully be reference, discloses methods and apparatus for simultaneously presenting multiple web pages from the World Wide Web on a computer display in a simulated three-dimensional (or theoretical four dimensional) environment in which the web pages are organized in a virtual spatial organization that is both logical and intuitive to the user. In one exemplary embodiment as illustrated in FIG. 1, the web pages are presented to the user on five simulated internal faces, 1, 2, 3, 4, 5, of a cube (with the sixth internal face of the cube theoretically positioned behind the user). The central web page appears essentially normally and the four web pages filling the four surrounding faces appear in polygonal shapes as shown. This presentation gives the illusion of looking upon a three-dimensional space, namely the inside of a cube with one face, the back face, removed. In other embodiments, the “cubic” display concept may be expanded both logically and in terms of the display. For instance, the computer display may present multiple cubes simultaneously, such as illustrated in FIG. 2, in which the display shows the cube from FIG. 1 plus four additional cubes spatially located around the original cube (i.e., a second cube spatially above the original cube, a third cube spatially to the left of the original cube, a fourth cube spatially to the right of the original cube, and a fifth cube spatially below the original cube) for a total of 25 web pages displayed simultaneously and organized in a spatial arrangement relative to each other. Each group of 5 faces is shaped and sized to look like the inside of a cube with one face removed. Preferably, the cubes (i.e., the groups of 5 faces) are arranged relative to each other to appear like a two-dimensional representation of a plurality of sides of adjacent cubes.

The spatial organization of the web pages may continue beyond the web pages that are currently being displayed to include other web pages (which may be stored in memory of the computer for quick access, even though not currently displayed). The user may navigate around the virtual space in any reasonable manner (e.g., placing a cursor over a particular page and clicking causes that particular page to move to the center of the display, with all other pages moving accordingly so as to maintain the spatial relationship of the pages). Thus, the movement of the pages may cause certain web pages to disappear from the display and other web pages that were previously not displayed to become displayed.

U.S. Pat. No. 6,922,815, also incorporated herein fully by reference, discloses additional features related to the methods and apparatus disclosed in the U.S. Pat. No. 6,938,218.

Such a display technique and spatial organization makes it simple, intuitive, and quick for a computer user to navigate amongst numerous web pages, particularly, logically related web pages because the spatial organization can emulate the logical relationship of the web pages. For instance, in one embodiment, web pages that hyperlink to each other may be spatially positioned adjacent to each other.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1 is a view of a first computer screen display of the prior art;

FIG. 2 is a view of a second computer screen display of the prior art;

FIG. 3 is a screenshot of a computer user interface in accordance with another embodiment;

FIG. 4 is a screenshot of a computer user interface in accordance with an exemplary embodiment;

FIGS. 5A through SD are exemplary graphical user interfaces in accordance with various embodiments; and

FIG. 6 is a computer user interface employing a QR Code in accordance with various embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

In accordance with an embodiment, the “cubic” organization and display paradigm disclosed in the aforementioned U.S. patents is extended and adapted to a virtual environment that may be shared and viewed by multiple computer users simultaneously, with each individual user able to view the virtual spatial environment from a unique perspective. The space may be populated with web pages from the world wide web and/or with any other computer readable and displayable data. In an embodiment, each face on the display (and further including faces that are not currently being displayed but exist in the virtual space outside of the current viewpoint) may correspond to any computer readable and/or computer displayable file or other form of data, such as web pages, word processing documents, spreadsheets, graphics files, audio files, video files, computer modeling files, email files, live feeds from cameras, and virtually any other type of file or other data construct that an individual might wish to view or otherwise interact with via a computer. For linguistic simplicity, the term “file” or “data unit” will be used herein for any such entity.

More particularly, in accordance with an embodiment, a virtual spatial environment comprising multiple (at least two) computer files may be created (and stored in memory) including data defining a virtual spatial relationship of the files to each other. The spatial relationship may be three dimensional, four dimensional, or any other number of spatial dimensions, with three dimensional space being preferable (and often used as an example in the following discussion). The data defining the spatial relationship of the files to each other may be composed of meta data within or otherwise associated with the individual files themselves or may be stored in a table separately from the individual files that occupy or comprise the virtual spatial environment. For instance, the spatial relationship data may be stored separately from the files in a table, wherein the table includes a data entry for each file containing data defining the spatial location of that file. For instance, for a three dimensional space, each entry in the table may comprise a 5-tuple data structure comprising (1) the identity of the file (e.g., a filename), (2) a coordinate (which may be a grid number) in the x dimension, (3) a coordinate (which may be a grid number) in the y dimension, (4) a coordinate (which may be a grid number) in the z dimension, and (5) a face type. More particularly, the x, y, and z coordinates/grid numbers data may define the location of the particular cube to which the file corresponds while the face type may define whether the file corresponds to the north, south, east, west, or rear face of the cube, wherein those face names are defined relative to the three-dimensional virtual space. For instance, the “rear” face of each cube is the face perpendicular to the Z axis of the virtual space and located toward the higher number grid coordinate. Once one of the faces is so defined, the other faces would inherently also be defined, e.g., the west face would be the face located perpendicular to the X dimension and located toward the lower grid number in the X direction, the east face would be the face perpendicular to the X dimension and located closer to the higher grid number in the X direction, the north face would be the face perpendicular to the Y dimension and located closer toward the higher grid number in the Y direction, and the south face would be the face perpendicular to the Y axis and located toward the lower grid number in the Y direction.

Note that the face names used in this discussion of absolute location of the cube faces within the virtual space (i.e., front, east, west, north, and south) are different than in other discussions in this specification (which, e.g., use the terms central, right, left, top, and bottom). This is because the terms central, right, left, top, and bottom are used in this specification as relative terms relative to the particular viewer, and, thus, do not define any particular orientation relative to the virtual space. That is, for example, the face of a cube that is called the “west” face in terms of its absolute position in the virtual space would only also be called the “left” face of the cube relative to a particular viewer if the viewer is viewing the virtual space with the Z dimension of the virtual space oriented in and out of the screen and looking into the screen toward higher grid numbers. If the viewer, were viewing the cube from a different orientation at any particular point in timer, then the west face of the cube could appear on the right, top, bottom, or central position to that particular viewer.

Alternately, the table itself may be structured such that the positions of the entries corresponding to those files within the table itself defines the locations (or at least a portion of the location information) of the files relative to each other in the virtual spatial environment.

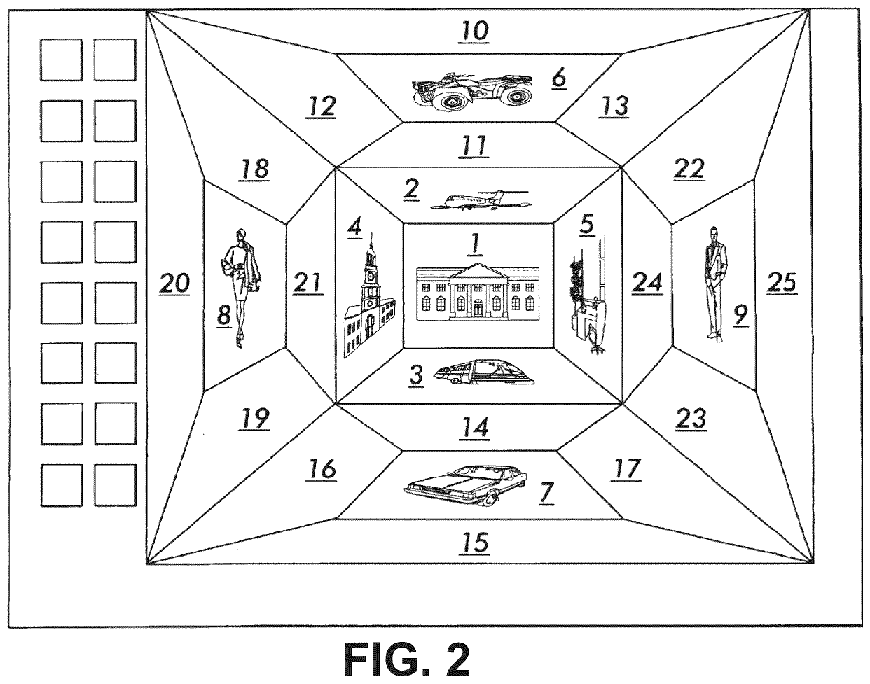

The spatial design, and particularly, the cube (or multiplicity of cubes such as shown in FIG. 2, for instance) is particularly useful as a collaborative workspace for allowing multiple individuals at different computers to work collaboratively and simultaneously on a project involving one or more of the files. For instance, consider a team of architects or designers working on plans for construction of a building (architectural plan computer files).

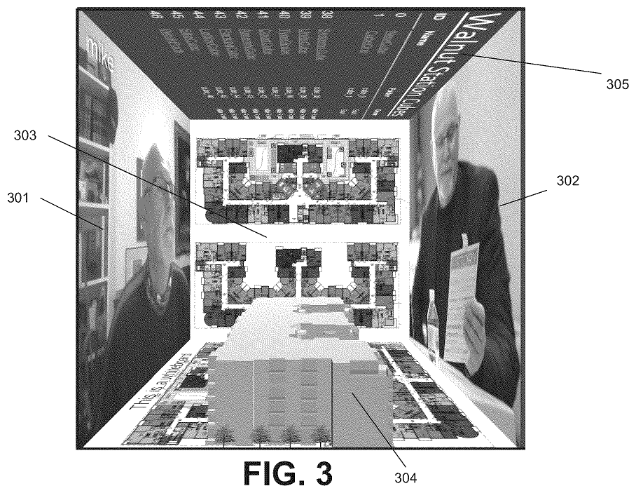

In a simple embodiment, such as illustrated by FIG. 3, the computer display device may display a single cube comprising six internal faces, five of which are viewable to any given user at any given instant (with the sixth face of the cube being logically positioned behind the viewer and thus not within the viewer's virtual field of vision). As an example, the five visible faces of the display cube, 301, 302, 303, 304, 305 may be populated with (1) a live video feed of a first collaborator (streaming from the first collaborator's web cam) displayed on the left face 301 of the cube, (2) a live video feed of a second collaborator (streaming from the second collaborator's web cam) displayed on the right face 302 of the cube, (3) an architectural plan displayed on the center face 303 of the cube, (4) a 3-D model of the building displayed on the bottom face 304 of the cube, (5) a word processing document containing relevant information about the building displayed in the top face 305 of the cube, and (6) a spreadsheet including cost information for individual features/aspects of the building on the back face (not in view in the configuration of FIG. 3) of the cube. In one preferred embodiment as illustrated in FIG. 3, the model is presented to appear as a three-dimensional model emanating from the bottom face 304 of the cube, e.g., occluding the content in the lower portion of the center face (in order to provide the illusion of being three dimensional within the two dimensional display screen).

Either or both of the two collaborators may edit the word processing file, the model file, the architectural plan file, and/or the spreadsheet file collaboratively while speaking with and seeing each other in the collaborative work environment.

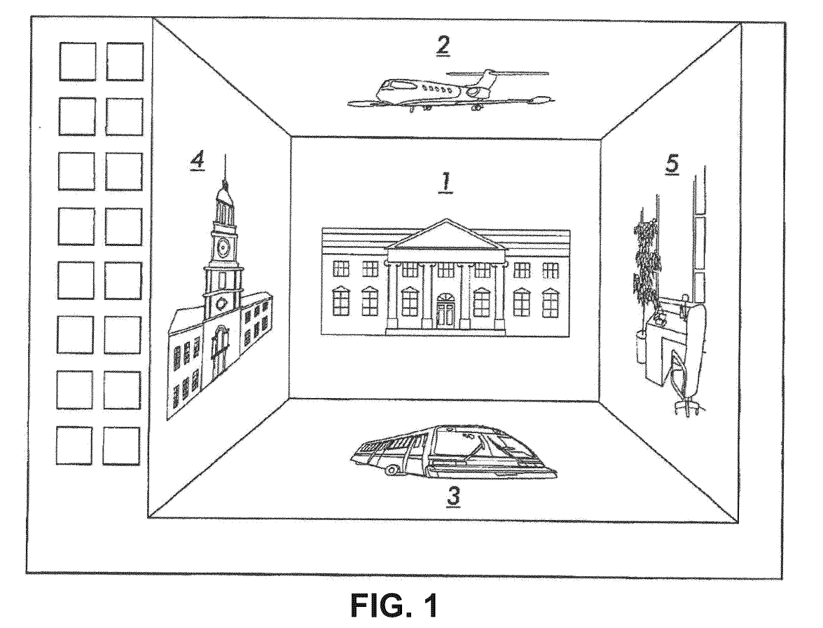

Of course, the above-described embodiment may be extended to add additional cubes with additional faces, such as seen in FIG. 2, for displaying additional computer files (including video streams of additional collaborators). FIG. 3 illustrates a single cube of the spatial construct. In certain embodiments, and particularly embodiments in which the virtual volume comprises multiple spatially organized cubes, the system may allow users to zoom in or out on the virtual volume to see as many faces/cubes as desired at any given instant. In an embodiment, specific zoom levels may be made available to the users. For instance, a first zoom level may cause a single face to be displayed to the user, a second zoom level may cause five faces of a single cube to be displayed to the user (e.g., see FIG. 1 or FIG. 3), a third zoom level may cause twenty five faces (five faces of each of a central cube and the four cubes spatially surrounding it) to be displayed to the user, and so on. In other embodiments, the zoom feature may be infinitely variable.

For instance, a user may wish to zoom out to view multiple cubes simultaneously in order to more easily visually find a particular file/face of interest and then zoom back in on that face of the cube to which that face belongs.

Also, fewer than all six faces of any one or more cubes may be occupied. For instance, in a collaborative environment, in which there are three collaborators/users and 5 additional files comprising the collaborative workspace (for a total of 8 files), then the virtual volume might be configured as two side-by-side cubes, each having four faces occupied and two faces unoccupied or blank. Alternately, the unoccupied faces may be populated with a random image, such as a wall of a room or a natural scene in order to best preserve a sense of being in a room or other real space with another person (or alone).

In certain embodiments, the virtual cube(s) may be constructed in an “open” configuration, e.g., the cube(s) comprise(s) only five faces, with the sixth side of the virtual cube not only being unoccupied by any file, but being visually presented on the computer display as open space (e.g., an open side of the cube). Such a configuration may, for instance, be preferable when there fewer than six files to be displayed for a given collaboration session.

In an embodiment, each collaborator may individually navigate to any location within the virtual volume so as to be viewing a particular face or plurality of faces that is different from the particular face or plurality of faces that another user/collaborator that has navigated to a different location in the virtual space is currently viewing. For instance, considering the simple example of a spatial environment comprising a single cube having six internal faces, each user may want to orient the cube so that the face containing their own live video stream from their own webcam is positioned as the back face of the cube from their perspective (so that they are not wasting a face within the display looking at themselves). Due to the intuitive spatial arrangement of the computer files in the virtual spatial environment, any user can easily navigate back to any location (or to any new location) within the space as needed.

The cube may be rotated in the display in any of the three degrees of rotational freedom (e.g., around a horizontal axis, around a vertical axis, and around an axis oriented in and out of the display screen). Rotation may be effected in any user-friendly and intuitive manner. For instance, using the display shown in FIG. 1 as an example, in one exemplary embodiment, clicking within any particular face (e.g., left face) causes the computer file data that was displayed on that face to move to rotate to the center position, 1. In other embodiments, particular keys on a keyboard or buttons on a controller may be designated as rotation control keys, e.g., button 1=rotate right, button 2—rotate left, button 3=rotate up, button 4=rotate down, button 5=rotate clockwise, and button 6=rotate counterclockwise.

In order to maintain the spatial and logical relationship of the computer files to each other, some or all of the other faces will also change position in the display. For instance, in the above example, the file on face 1 would move to face 5. Likewise, the file on face 5 of the cube would rotate out of view to the unseen back face of the cube, and the file that had been logically and spatially on the unseen back face of the cube would move to face 4. In this particular example, the computer files displayed on top face 2 and bottom face 3 would remain on those faces, respectively, but may rotate ninety degrees within those faces to maintain the spatial relationships of the files/faces.

Of course, the collaborative workspace embodiment is merely exemplary. In another exemplary embodiment, up to five individuals can simply watch a movie (or play a video game) together in the single cube environment, placing the face showing the movie/game in the center face and live streams of the web cams of each of the four other participants positioned in the left, right, top, and bottom faces on his or her individual display, respectively, and the video stream from his or her own web cam on the back/unseen face of the cube. Thus, each user would have his or her cube rotated to a different orientation so as to see the movie and the four other participants (but not his/her-self) on the display screen.

Depending on the particular use of the virtual spatial environment, as the cube is rotated, the environment may be controlled so that content that is being displayed in one or more of the faces always remains in the same orientation. For example, in the aforementioned movie watching environment, it is unlikely that any of the user wishes to watch the movie upside down (or in any orientation other than right side up), i.e., each user would prefer that the movie is always displayed with the top of the picture facing up and uninverted left to right. In fact, it is likely that they would have the same preference for the video streams of their friends' faces. Thus, in such an application, the programming for creating the virtual spatial environment would control all of the feeds to the faces to always maintain their particular orientation within the face. However, other applications can be envisioned in which the image in one or more the faces of the cube(s) do rotate according to the particular rotation of the viewpoint of the individual user.

In certain embodiments, a feature may be provided such that one or more selected faces do not move when the cube is rotated. For instance, in the movie watching scenario, it may be desirable to lock the movie on the center face of the cube for each user regardless of the orientation of the cube. To maintain the spatial organization, the content that should be displayed on that face according to the spatial organization may be considered to be located in that same space/face, but occluded by the always-there content (the movie).

While, in the simple example of a single cube primarily discussed thus far movement has been described in terms of a rotation of the cube, this is merely exemplary. Movement in the virtual spatial environment also may include translation through a space that comprises multiple cubes. In one embodiment, a user interface feature may be provided whereby positioning one's cursor within any face in the display and clicking (i.e., activating a particular button of a mouse or other controller apparatus) causes that face to move to the center face of the center cube (and all other content to move accordingly per the spatial plan, including the possibility of some content moving out of view and other, previously unseen, content moving into view). Thus, for instance, referring to an exemplary virtual environment such as illustrated in FIG. 2 comprising five cubes (twenty five faces) being simultaneously displayed (plus potentially other cubes/faces existing in the virtual space, but not being currently displayed), clicking on a particular face of a particular cube may cause the cube to which that face belongs to translate to the center of the virtual space and that face to be the central face of that cube, with all other files in the entire virtual space also translating and rotating commensurately in accordance with the virtual spatial arrangement.

In other embodiments, particular buttons on a keyboard or controller or particular virtual buttons displayed on the screen may be pressed or otherwise operated to effect translation (or rotation) in the virtual space. For instance, the four arrow buttons commonly found on a computer keyboard may be used to translate through the virtual space (e.g., translating up, down, left, or right). In a three-dimensional virtual space, two additional buttons (or other interface mechanisms) may be needed to effect translations in the third dimension (i.e., in and out of the screen). In a four or greater dimensional virtual space, even further buttons may be needed to effect translation in those additional dimensions. In such embodiments, a user could, therefore, “click on” a face or otherwise interact with a face/file on the display in a normal fashion without necessarily moving it to the center of the display, i.e., a user does not need to move that page into the center window in order to interact with it.

While the description herein of particular embodiments has thus far related to computer screen displays, the concepts can also be implemented in connection with a head-mounted display or other forms of virtual reality display.

In addition, a zoom feature may be provided in accordance with an embodiment. For instance, a user may zoom in or out on the space by use of a scroll wheel on a mouse or any other user interface tool, such as any of the aforementioned (i) virtual buttons shown on the screen or virtual environment, (ii) keyboard or controller buttons, (iii) wheels, and (iv) toggle sticks. A user may zoom all the way in such that the display shows only a single face, and may zoom out to show a single cube (5 faces. e.g., see FIG. 1), the faces of five adjacent cubes (25 faces, e.g., see FIG. 2), the faces of 25 cubes, etc.

In the examples discussed and shown thus far, the display shows five faces of each cube that is within the field of view of the particular user. However, this is merely an implementation detail. In other embodiments, different cubes may be displayed in different manners. For instance, in one exemplary implementation, all cubes other than the cube in the center of the display may be shown as “closed” (unless and until moved to the center of the display). In such an implementation, the “closed” cubes may each appear as a single face. In an implementation, that face may contain text or another form of graphic information that conveys the general nature of what is inside that cube (i.e., a common trait of the files corresponding to the faces of that cube). For instance, continuing with the previous example of a collaborative environment for an architectural firm discussed above in connection with FIG. 3, each cube (or a set of multiple adjacent cubes) may correspond to a different project, building, client, etc.

For purposes of logical continuity with the spatial organization theme of the present invention, one may logically consider the single face of a “closed” cube that is seen in this type of implementation to be the outer face of the back panel of that cube (and which is blocking the view of the five internal faces of that cube). However, alternately, for instance, one could just as easily conceptualize it as viewing a label for the corresponding cube, rather than the cube itself without affecting the spatial organization concept in any way.

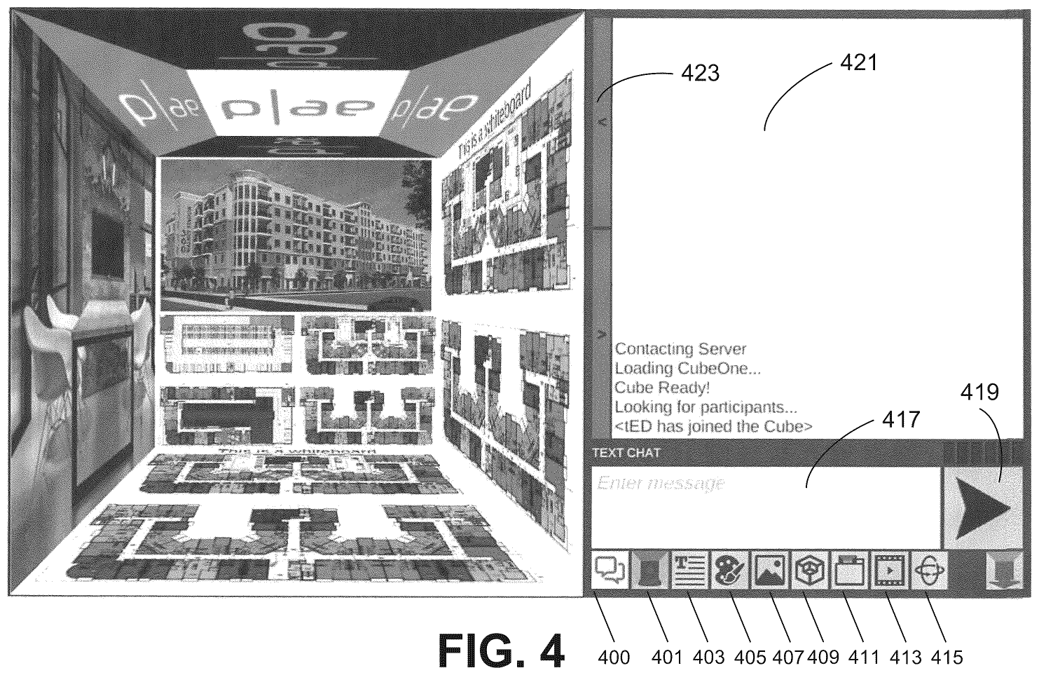

FIG. 4 is a screenshot of an exemplary graphic user interface for interacting with the collaborative workspace. As can be seen, in this embodiment, the left-hand half of the screen is occupied with the display of the virtual spatial environment as described hereinabove (presenting a single cube in this example). The right-hand half of the screen is occupied with mode buttons (e.g., virtual buttons that the user may operate by positioning a cursor over the displayed button and left clicking a mouse controller) corresponding to tools for conveniently interacting with the virtual spatial environment.

The mode buttons may include a TEXT CHAT button 400, A WEB CAM button 401, a TEXT TOOLS button 403, a DRAWING TOOLS button, 405, an IMAGE TOOLS button 407, a MODEL button 409, a FILE TOOLS button, 411, a VIDEO button 413, and a VERTICAL SPIN TOGGLE button 415

In an embodiment, when a user's system is in a particular mode, the mode button corresponding to that mode may be illuminated or otherwise visually altered to distinguish it from the other mode buttons to visually cue the user as to which mode his or her system is currently in.

In an embodiment, when a user first enters a virtual volume, the system may default open in text chat mode. In an embodiment, text messages, alerts, and/or other messages may be displayed in a staging area 417.

If a user is in another mode, and wants to return to text chat mode, the user may press button 400 to return to text chat mode.

To send a text message to the other users/collaborators currently in the cube, one may position a cursor in area 417 and click and start typing, and then press ENTER or tap the arrow button 419 to send the message to the other users in the cube/virtual space. Anything a user types in this area will be seen by the other users in the cube when sent, with the originating user's screen name attached.

Next is the WEB CAM mode button 401. To preview one's web cam, a user may press the WEB CAM button 401, to cause his or her webcam feed to be displayed in a staging area 421. To insert the web cam feed into one of the faces of the cube so that everyone else can see it, the user may press the button 423 that is located to the left of the web cam preview area 421. Button 423 may be configured to light up or (become otherwise visually distinguished) when one previews his/her web cam. In an embodiment, web cams may be assigned to faces in the cube/virtual space in the order that they join, so that the user does not need to select a panel or do anything further. In one embodiment, the order in which web cam feeds are inserted onto the faces of the cube may be front, back, left, and right. In an embodiment, the first one into the cube will see him- or her-self on the front center panel. The second or subsequent person entering the cube, will see the person(s) who entered the cube before them on the faces of the cube, and their webcam will be on the back panel. To see one's own web cam feed, or to see the web cam of someone else who inserts theirs, a user may need to rotate the cube. To remove one's web cam from a face of the cube, a user may press the Web Cam mode button 401 again.

In an embodiment, any video source that a user's computer recognizes as a camera can be inserted into the cube in place of a web cam. In one implementation, a DeckLink MiniRecorder card from Black Magic may be used to route an HDMI output from a Virtual Reality headset into a computer via the HDMI input terminal on the MiniRecorder card. The MiniRecorder presents the HDMI output to the computer as a camera, which allows the service to place it into the cube.

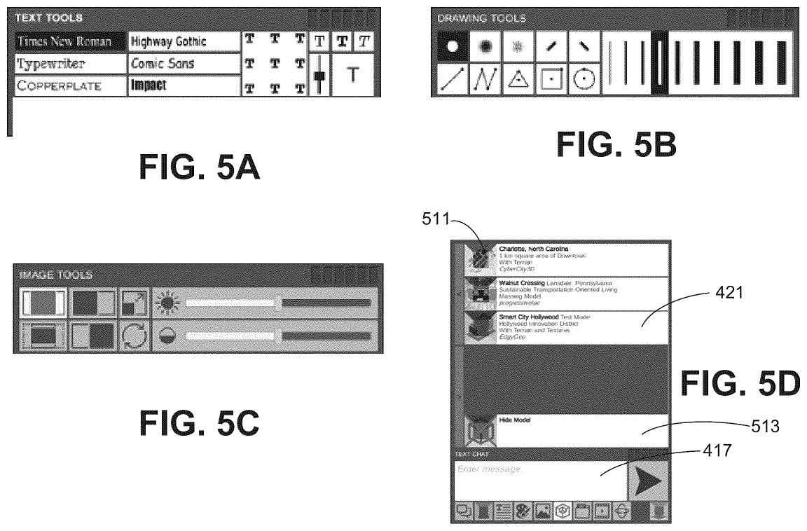

A TEXT TOOLS mode button 403 may be provided that, when actuated, opens a menu of text tools for providing functionality for placing text over items (images, in most cases) in the staging area 421 and/or over images appearing in the cube. In an embodiment, actuating the text tools mode button 403 may cause a graphical user interface segment such as seen in FIG. 5A to be displayed in area 417 of the display (corresponding to where the text box appears when in text chat mode). Text tools may include fonts, font size, font style and text alignment.

In an embodiment, a DRAWING TOOLS mode button 405 similar to the TEXT TOOLS 403 button may be provided, which opens a menu such as seen in FIG. 5B into drawing tools for adding drawings over items (images, in most cases) appearing in the staging area 421 and/or over images appearing directly in the cube. In embodiments, the drawing tools may further include tools such as color, erase, undo, clear, etc.

In an embodiment, an IMAGE TOOLS mode button 407 may be provided that opens a menu, such as illustrated in FIG. 5C, of functions for placing an image into the cube. A user may enter this mode by pressing the IMAGE TOOLS button 407. In an embodiment, this causes a file selector to appear (not shown) that will allow the user to select a file from the user's computer. Selecting an image may cause the selected image to appear in the staging area 421. Pressing the left arrow 423 and selecting a face of the cube will put the image onto that face.

In an embodiment, a MODEL mode button 409 may be provided. Pressing the MODEL button 409 may cause a list of available models, to appear in the staging area 421, such as illustrated in FIG. 5D. The text chat box 417 may remain displayed in this embodiment. These may be models that have previously been processed and attached to the cube by the owner or creator of the cube, so that they will be available to users that join that cube. A model may be selected by clicking the icon (e.g., 511) next to the model description. The model will be inserted into the cube for everyone to see. To remove (hide) the model, one may press the MODEL button 409 again, and select the HIDE MODEL button 511 from the list (e.g., at the bottom of the list).

In an embodiment, a FILE TOOLS mode button 411 may be configured to bring up a number of options that may be used to manipulate the entire cube. These tools may include: (1) Restore, which restores the cube to its original state after images, video, etc. have been inserted; (2) Clear, which clears the cube of all content so that one may start fresh to create an all new cube; and (3) Save, which saves the current cube with a new name.

In an embodiment, a VIDEO mode button 413 may be provided with related features that may work much like IMAGE insertion as described above in connection with the IMAGE TOOLS button 407, and allows a user to insert videos into the cube, using a similar process. For instance, when one selects the VIDEO mode button 413, a video preview appears in the staging area 421. In an embodiment, this causes a file selector to appear (not shown) that will allow the user to select a file from the user's computer. Selecting a video may cause the selected video to replace the list in the staging area 421. Pressing the left arrow 423, and then clicking in a face of a displayed cube causes the video to appear in that face. Like images, videos can be inserted into faces that do not currently have web cams or another video.

Similarly to what was described above with respect to the Model mode, in an embodiment, clicking on the Video mode button 413 may cause a list of videos to be presented to the user that have previously been attached to the cube by the owner or creator of the cube.

In an embodiment, the display may be configured such that, by default, the cube can be rotated only about a vertical axis. This feature may be beneficial as it may make it easier for the users to keep track of the orientation. However, some application may require rotations on a horizontal axis (vertical spin) as well. Thus, a VERTICAL SPIN TOGGLE button 415 may be provided to toggle the horizontal axis rotation capability on and off.

Additional features that may be provided, including interactive models. With this feature, the models (see, e.g., 304 in FIG. 3 and the related discussion above) may include “hot spots” than can be clicked on to trigger the display of additional information relevant to what is displayed in corresponding hot spot. This provides an ability to display models that are connected with a database that can be interrogated using the model itself as an interface.

In another embodiment, faces of the cube may also contain hot spots or hyperlinks linked to other faces of cubes in the virtual space, models, videos, or virtually any other content. Hot spots on panels can be linked to a change in the same panel, a change in another panel, the loading of a model, the playing of a video, etc.

In an embodiment, a face of a cube may contain a OR (Quick Response) code. The OR code may be scanned by a user either with a separate device, such as the camera of a cellular telephone, or directly using the processing device that is causing the OR code to be displayed on the display device. In either event, the OR code may be associated with a URL (or other linking means) that links to the other content. By scanning the OR code (e.g., with another device), the user is taken to the associated URL, etc. to view and potentially interact with the other content.

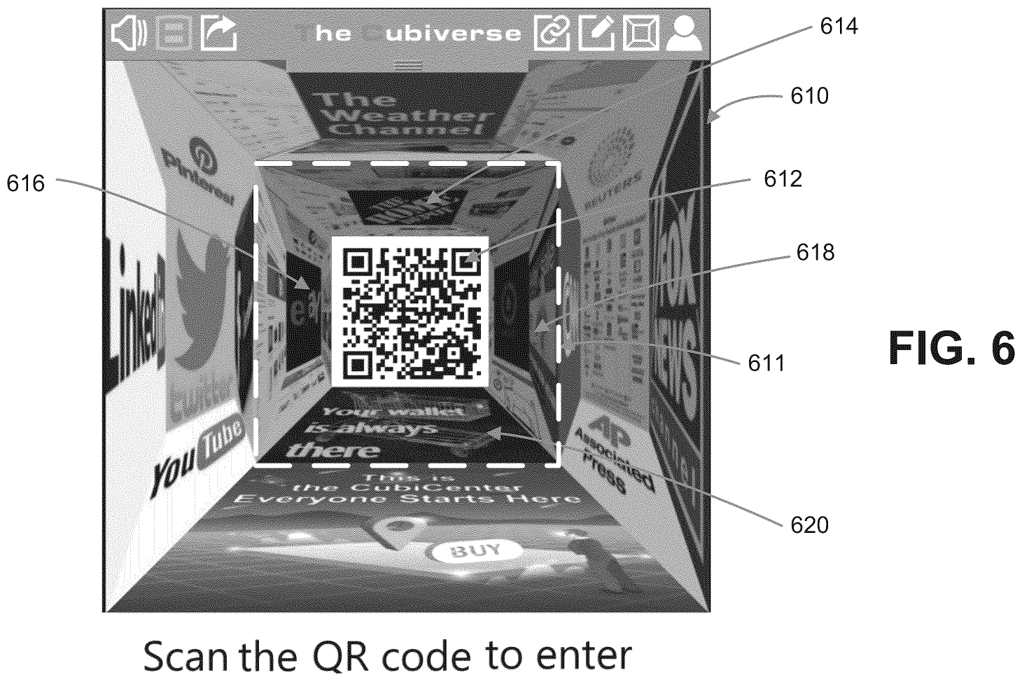

In an embodiment, the OR code may be displayed within a larger image that illustrates (or otherwise discloses) the content to which the associated URL (or other linking means) leads. For instance, referring to FIG. 6, in an embodiment, the back face 611 of a cube 610 (face 611 is also outlined with a yellow dashed line to help identify its boundaries) may display a OR code 612 in the middle of the face 611 that is associated with a link to another cube). The area of the face 611 surrounding the OR code may display an image of some or all of the faces of another cube (or of multiple cubes) that correspond to the link associated with the OR code. In an embodiment, the link may lead to (or be associated with) another portion of the overall virtual space. However, in other embodiments, the link may lead to content not part of the virtual space or a combination of both.

In FIG. 6, for instance, the area surrounding the OR code 612 displays the various faces of three other cubes (displayed to the top, left, and right of the QR code 612) that are in another volume of the virtual space as well as a single web page that is displayed to the bottom of the OR code. More particularly, a first cube 614 appears above the OR code 612 and comprises five faces. A second first cube 616 appears to the left of the OR code 612 and comprises five faces. A third cube 618 appears to the left of the OR code 612 and comprises five faces. Finally, below the OR code appears a simple single web page (or other content).

While cubes 614, 616, and 618 are described in the afore described example as comprising another volume of the virtual space (i.e., they are spatially related to each other in the manner illustrated in face 611), it should be understood that this is merely exemplary. In other embodiments, the cubes 614, 616, and 618 may be independent cubes not related by any relative spatial organization and/or not even comprising part of the virtual space or may not be cubes at all. The content displayed along with the OR code can be almost anything that can be viewed by a human and understood by that human to provide information as to the content to which the OR code corresponds (hereinafter sometimes referred to as “human-readable”).

In a previously described embodiment, all cubes other than the cube in the center of the display may shown as “closed”, wherein, the “closed” cubes each appear as a single face that may contain text or another form of graphic information that conveys the general nature of what is inside that cube (e.g., for an architectural firm, each cube may correspond to a different project, building, or client). In certain embodiments, that single face may also contain a OR code along with the information about the contents of the corresponding cube as described immediately above. In an embodiment, this would allow a user to “open” that cube on another device by scanning the OR code with the camera of the other device.

The concept of an image bearing a OR code that also simultaneously shows some representation of the content to which the link associated with the OR code leads is not limited to use in the collaborative workspace environment described herein above, to cubes, or even to virtual space environments as described herein above. The concept may be implemented in connection with any OR or other machine-readable code or other electronic linking means. For instance, any OR code may be presented along with text describing the content at the location to which it links or an image of the web page to which it links.

Furthermore, the concept is not limited to OR codes, but may be applied to any visual or other sensory representation that is machine-readable and that, when read (or otherwise sensed) by an electronic device, causes that device to access a webpage or any other information. Examples includes barcodes, alphanumeric codes, numeric codes, alphabetical codes, symbolic codes, etc.

Yet further, the concept is not even limited to linking to webpages, cubes, hypercubes, or other content available via the internet, but can link to virtually any content. For instance, in other embodiments, the machine readable codes may link to other computer files stored on a computer, contained within a local area network (LAN), or contained on any other computer network.

In yet other embodiments, the machine-readable code need not even be visually or optically perceptible, but may be anything that a machine can perceive.

### CONCLUSION

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed.” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A. B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

1. An at least partially machine-readable image comprising:
a first image portion comprising a machine-readable code that identifies corresponding content on a communication network, which code may be read by a machine to cause that machine to access the corresponding content; and
a second image portion comprising a visual representation of the corresponding content.

2. The at least partially machine-readable image of claim 1 wherein the machine-readable code is a QR code.

3. The at least partially machine-readable image of claim 1 wherein the machine-readable code is a barcode.

4. The at least partially machine-readable image of claim 1 wherein the machine-readable code is an alphanumeric code.

5. The at least partially machine-readable image of claim 1 wherein the second image portion comprises a textual description of the corresponding content.

6. The at least partially machine-readable image of claim 1 wherein the second image portion comprises an image of at least a portion of the corresponding content.

7. The at least partially machine-readable image of claim 1 wherein the first image portion identifies a hyperlink to content on the internet.

8. The at least partially machine-readable image of claim 1 wherein the first image portion identifies a link to content on a communication network.

9. A computer program product comprising a non-transitory computer-readable storage medium containing computer program code, the computer program code when executed by one or more processors causes the one or more processors to perform operations, the computer program code comprising instructions to cause a display device to display an image comprising a first image portion comprising a machine-readable code that identifies corresponding content on a communication network, which code may be read by a machine to cause that machine to access the corresponding content and a second image portion comprising a visual representation of the corresponding content.

10. The computer program product of claim 1 wherein the machine-readable code is a QR code.

11. The computer program product of claim 1 wherein the machine-readable code is a barcode.

12. The computer program product of claim 1 wherein the machine-readable code is an alphanumeric code.

13. The computer program product of claim 1 wherein the second image portion comprises a textual description of the corresponding content.

14. The computer program product of claim 1 wherein the second image portion comprises an image of at least a portion of the corresponding content.

15. The computer program product of claim 1 wherein the first image portion identifies a hyperlink to content on the internet.

16. The computer program product of claim 1 wherein the first image portion identifies a link to content on a communication network.

17. An electronic communication device configured to generate a at least partially machine-readable image comprising a first image portion comprising a machine-readable code that identifies corresponding content on a communication network, which code may be read by a machine to cause that machine to access the corresponding content and a second image portion comprising a visual representation of the corresponding content.

18. The electronic communication device of claim 17 wherein the machine-readable code is a QR code.

19. The electronic communication device of claim 17 wherein the second image portion comprises an image of at least a portion of the corresponding content.

20. The electronic communication device of claim 17 wherein the first image portion identifies a hyperlink to content on the internet.
